(19) United States
(12) Patent Application Publication
(10) Pub. No.: US 2025/0342703 A1
(43) Pub. Date: Nov. 6, 2025

(54) MONITORING DEVICE

(71) Applicant: TOYOTA JIDOSHA KABUSHIKI KAISHA, Toyota-shi Aichi-ken (JP)

(72) Inventor: Kenichiroh Hara, Yokohama-shi Kanagawa-ken (JP)

(73) Assignee: TOYOTA JIDOSHA KABUSHIKI KAISHA, Toyota-shi Aichi-ken (JP)

(21) Appl. No.: 19/188,541

(22) Filed: Apr. 24, 2025

(30) Foreign Application Priority Data
May 1, 2024 (JP) 2024-074441

(51) Int. Cl. G06V 20/59

(52) U.S. Cl. CPC G06V 20/597

(57) ABSTRACT

A monitoring device has a processor configured to determine whether a driver is looking aside based on information representing a direction of a face of the driver using a predetermined determination criterion, determine whether a current position of the host vehicle is within a roundabout based on map information, and change the determination criterion so that it has not been determined that the driver is looking aside when the face of the driver is facing in the direction of an entry point of another vehicle to the roundabout, when it has been determined that the current position of the host vehicle is within the roundabout.

### CROSS-REFERENCE TO RELATED APPLICATIONS

This application claims priority to Japanese Patent Application No. 2024-074441 filed May 1, 2024, the entire contents of which are herein incorporated by reference.

### FIELD

The present disclosure relates to a monitoring device.

### BACKGROUND

Conventionally, a monitoring device is mounted on the vehicle to monitor the state of a driver. For example, the monitoring device monitors whether the driver is looking aside.

The monitoring device notifies a warning if the monitoring device determines that the driver is looking aside when the driver is facing a direction at or above a predetermined angle in the horizontal direction with respect to the traveling direction of the vehicle.

The driver looks at the direction of the entry point when the vehicle is traveling at an entry point where another vehicle enters at an intersection, etc. This is an action for safety confirmation, and the determination criterion for looking aside has been relaxed, since it is bothersome for the driver to be notified of warnings for such action (e.g., see Japanese Unexamined Patent Publication No. 2007-226666).

For example, a longer reference time is proposed as a relaxation of the determination criterion if it has been determined that a driver is looking aside when the total time of looking aside exceeds a reference time during a predetermined determination period.

### SUMMARY

A vehicle may travel through a roundabout (cyclic intersection). The roundabout has a ring road and a plurality of entry points where other vehicles enter the ring road. The driver checks whether another vehicle enters from the entry point when the vehicle is traveling within a roundabout.

The total time of looking aside may exceed the reference time even if the determination criterion is relaxed, since the entry points frequently appear within the ring road of the roundabout. If the time of looking aside exceeds the reference time, a warning will be notified to the driver.

Accordingly, an object of the present disclosure is to provide a monitoring device that does not determine that the driver is looking aside within the roundabout even if the driver is looking at an entry point of another vehicle to the roundabout.

(1) According to one embodiment, a monitoring device is provided. This monitoring device has a processor configured to determine whether a driver is looking aside based on information representing a direction of a face of the driver using a predetermined determination criterion, determine whether a current position of the host vehicle is within a roundabout based on map information, and change the determination criterion so that it has not been determined that the driver is looking aside when the face of the driver is facing in the direction of an entry point of another vehicle into the roundabout, when it has been determined that the current position of the host vehicle is within the roundabout.

(2) In the monitoring device of the embodiment (1), the processor is further configured to determine that the current position of the host vehicle is within the roundabout when it has been determined that the current position of the host vehicle is within the roundabout based on the map information and it has been determined that entering operation of the host vehicle into the roundabout has been completed.

(3) In the monitoring device of the embodiment (1) or (2), the monitoring device according to claim 2, wherein the processor is further configured to determine that the entering operation of the host vehicle has been completed when a steering angle of a steering wheel of the host vehicle becomes zero from a steering angle in the first direction for entering the roundabout and becomes a steering angle in the second direction opposite to the first direction, or when a yaw rate of the host vehicle changes from a yaw rate in the first direction to zero and changes to a yaw rate in the second direction.

(4) In the monitoring equipment of the embodiments (1) to (3), the processor is further configured to determine whether operation to a winker operating unit representing a change in a traveling direction of the host vehicle for exiting the roundabout has been carried out at an exit point where the host vehicle exits the roundabout, and change the determination criterion to an initial value before the change of the determination criterion, when it has been determined that the operation to the winker operating unit is carried out.

(5) In the monitoring device of the embodiments (1) to (4), the processor is further configured to change the determination criterion to be relaxed for the face of the driver facing in the curved direction of a road on which the host vehicle is traveling, when it has been determined that the current position of the host vehicle is within the roundabout.

The monitoring device according to the present disclosure can prevent the driver from being notified of the warning within the roundabout, since the monitoring device does not determine that the driver is looking aside even if the driver is looking at the entry point of another vehicle into the roundabout.

The object and advantages of the present disclosure will be realized and attained by the elements and combinations particularly specified in the claims. It is to be understood that both the foregoing general description and the following detailed description are exemplary and explanatory, and are not restrictive of the present disclosure as claimed.

### BRIEF DESCRIPTION OF DRAWINGS

FIG. 1A is a diagram illustrating operation of a monitoring device of a present embodiment in overview and showing a vehicle in a roundabout.

FIG. 1B is a diagram illustrating operation of the monitoring device of the present embodiment in overview and showing a cabin of the vehicle.

FIG. 2 is a hardware configuration diagram of the vehicle in which the monitoring device of the present embodiment is mounted.

FIG. 3 is an example of an operation flow chart for change processing by the monitoring device of the present embodiment.

FIG. 4 is an example of an operation flowchart for determination processing by the monitoring device of the present embodiment.

FIG. 5 is an example of an operation flowchart by a modified example 1 of the monitoring device of the present embodiment.

FIG. 6 is an example of an operation flowchart by a modified example 2 of the monitoring device of the present embodiment.

### DESCRIPTION OF EMBODIMENTS

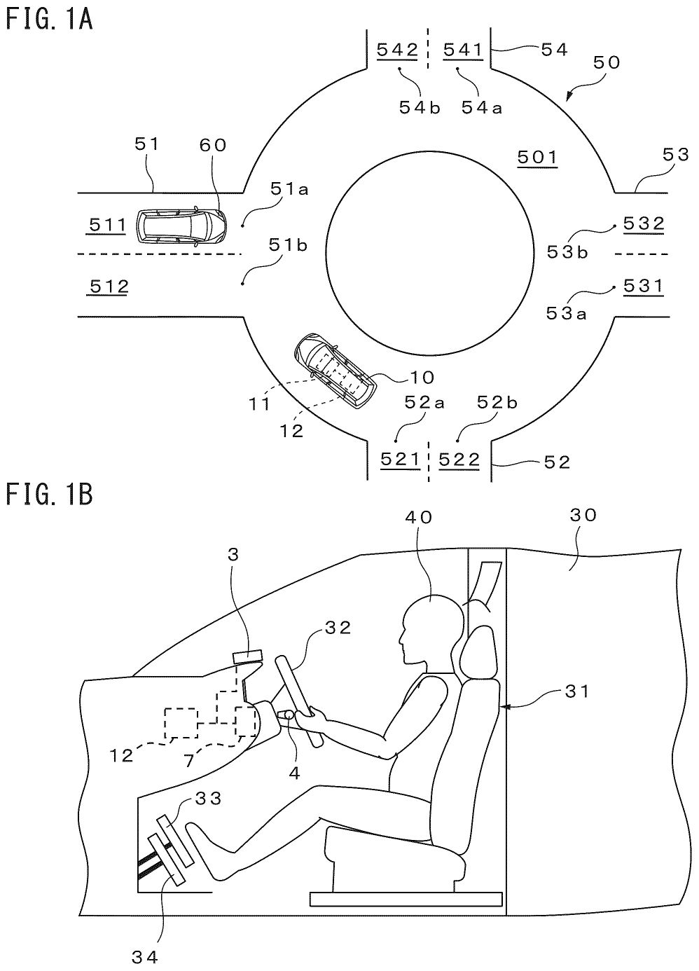

FIG. 1A and FIG. 1B are diagrams illustrating operation of a monitoring device of a present embodiment in overview. FIG. 1A shows a vehicle 10 in a roundabout, and FIG. 1B shows a cabin 30 of the vehicle 10.

As shown in FIG. 1A, the vehicle 10 has an automatic control device 11 and a monitoring device 12. The automatic control device 11 has an automatic operation mode (for example, driving modes from levels 3 to 5) in which the automatic control device 11 primarily operates the vehicle 10, and a manual operation mode (for example, driving modes from levels 0 to 2) in which a driver 40 primarily operates the vehicle 10. The vehicle 10 may be an autonomous vehicle.

In the manual operation mode, the automatic control device 11 controls the operation of the vehicle 10 based on the operation of the driver 40. The driver 40 is seated in the driver's seat 31 so that the steering wheel 32, brake pedal 33, and accelerator pedal 34 are operable in the cab 30.

The monitoring device 12 monitors whether the driver 40 is looking aside based on the monitoring image representing the driver 40 acquired by the monitoring camera 3.

The vehicle 10 is traveling within a roundabout (cyclic intersection) 50. The roundabout 50 has a ring road 501. The ring road 501 has a ring shape. The vehicle 10 is traveling on the ring road 501. Four roads 51-54 are connected to the ring road 501. The roundabout 50 has the ring road 501 and four entry points 51a˜54a into which other vehicles can enter the ring road 501 and four exit points 51b˜54b where the vehicle 10 can exit the ring road 501.

The road 51 has a lane 511 and a lane 512. The connecting position between the lane 511 and the ring road 501 forms an entry point 51a. The connecting position between the lane 512 and the ring road 501 forms an exit point 51b. The road 52 has a lane 521 and a lane 522. The connecting position between the lane 521 and the ring road 501 forms an entry point 52a. The connecting position between the lane 522 and the ring road 501 forms an exit point 52b. The road 53 has a lane 531 and a lane 532. The connecting position between the lane 531 and the ring road 501 forms an entry point 53a. The connecting position between the lane 532 and the ring road 501 forms an exit point 53b. The road 54 has a lane 541 and a lane 542. The connecting position between the lane 541 and the ring road 501 forms an entry point 54a. The connecting position between the lane 542 and the ring road 501 forms an exit point 54b.

The vehicle 10 is traveling on the ring road 501 while curving. The entry points 51a˜54a and the exit points 51b˜54b are located on the opposite side to the direction in which the vehicle 10 turns with respect to the vehicle 10.

In the example shown in FIG. 1A, the vehicle 10 is traveling in front of the entry point 51a. The vehicle 60 is about to enter the ring road 501 from the entry point 51a.

The driver 40 turns the driver's face toward the entry point 51a for safety confirmation. The entry point 51a is located on the opposite side to the direction in which the vehicle 10 turns, so that the drivers 40 will turn the driver's face to the left side to a large extent with respect to the traveling direction of the vehicle 10.

When the monitoring device 12 monitors the driver 40 in this state using the determination criterion of the initial value, the monitoring device 12 determines that the driver 40 is looking aside.

However, it may be bothersome for the driver 40 to be notified of the warning by the monitoring device 12, since the driver 40 is looking at the entry point 51a for safety confirmation.

Therefore, the monitoring device 12 changes the determination criterion so that it has not been determined that the driver 40 is looking aside when the face of the driver 40 is facing in the direction of the entry points 51a˜54a of other vehicles into the roundabout 50, when it has been determined that the current position of the vehicle 10 is within the roundabout 50.

The monitoring device 12 uses the changed determination criterion to determine whether the driver 40 is looking aside. Thus, the monitoring device 12 is able to prevent the driver 40 from being notified of the warning to because it is not determined that the driver 40 is looking aside, even if the driver is looking at the entry point 51a for safety confirmation.

As described above, the monitoring device 12 of the present embodiment can prevent the driver 40 from being notified of the warning within the roundabout 50, since the monitoring device 12 does not determine that the driver 40 is looking aside, even if the driver 40 is looking at the entry point of another vehicle into the roundabout.

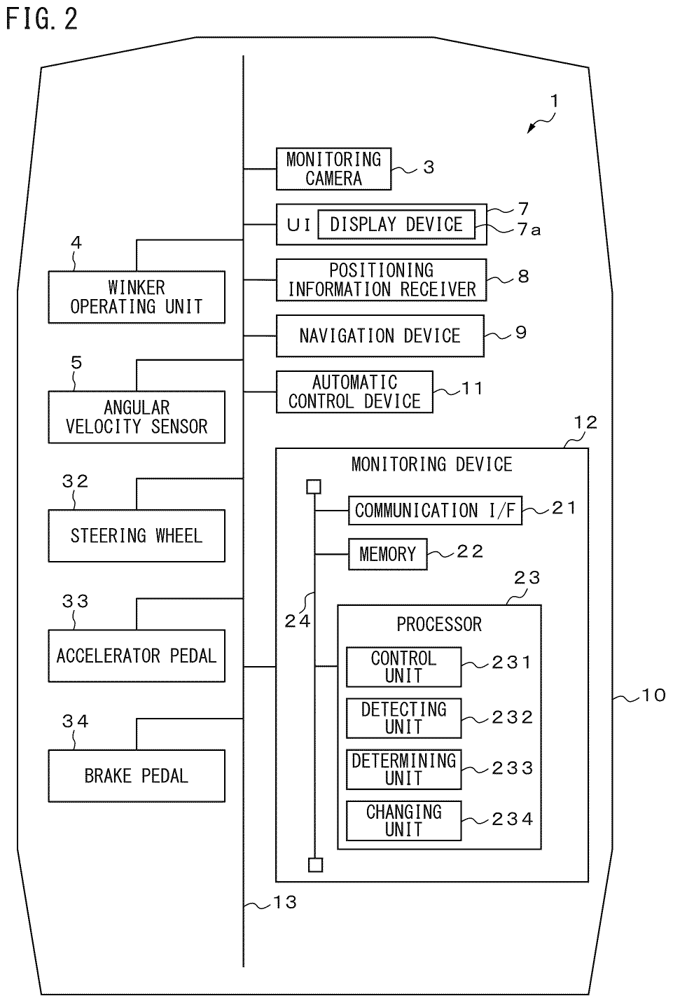

FIG. 2 is a hardware configuration diagram of the vehicle 10 in which the monitoring device 12 of the present embodiment is mounted. The vehicle 10 has a monitoring camera 3, a winker operating unit 4, an angular velocity sensor 5, a user interface (UI) 7, a positioning information receiver 8, a navigation device 9, an automatic control device 11, a monitoring device 12, a steering wheel 32, an accelerator pedal 33 and a brake pedal 34, etc. The vehicle 10 may further has a range finding sensor, such as a LiDAR sensor.

The monitoring camera 3, the winker operating unit 4, the angular velocity sensor 5, UI 7, the positioning information receiver 8, the navigation device 9, the automatic control device 11, the monitoring device 12, the steering wheel 32, the accelerator pedal 33 and the brake pedal 34 are communicatively connected via an in-vehicle network 13 conforming to the Controller Area Network standard.

The monitoring camera 3 is disposed inside the cabin 30 to acquire a monitoring image including the face of the driver 40 driving the vehicle 10. The monitoring camera 3 is disposed, for example, on a dashboard. The monitoring camera 3 is an example of an image capturing unit. For example, the monitoring camera 3 acquires monitoring images at a monitoring image acquisition time having a predetermined cycle. The monitoring image represents an area near the driving seat 40. The monitoring image represents the face of the driver 40 seated in the driver's seat 31.

The monitoring camera 3 has a 2D detector composed of an array of photoelectric conversion elements with infrared sensitivity, such as a CCD or C-MOS, and an imaging optical system that forms an image of the captured region on the 2D detector. Each time a monitoring image is acquired, the monitoring camera 3 outputs the monitoring image and the image acquisition time at which the monitoring image has been acquired to the monitoring device 12 via the in-vehicle network 13. The monitoring image is used in the monitoring device 12 to detect the direction of the face of the driver 40.

The winker operating unit 4 is disposed on the steering column. The winker operating unit 4 inputs the direction of the lane change of the vehicle 10. The driver 40 instructs the change of the traveling direction of the vehicle 10 by operating the winker operating unit 4 on the upper side or the lower side. The winker operating unit 4 outputs a winker operation signal representing a change in the traveling direction of the vehicle 10 to the automatic control device 11, the monitoring device 12, etc. via the in-vehicle network 13. The winker operation signal is an example of operation information representing the operation of the driver 40 to the winker operating unit 4. The monitoring device 12 stores the winker operation signal together with the time when the winker operation signal is input.

The angular velocity sensor 5 detects the yaw rate of the vehicle 10 and outputs the yaw rate and the yaw rate acquisition time at which the yaw rate has been acquired to the automatic control device 11, the monitoring device 12, etc. via the in-vehicle network 13. As the angular velocity sensor 5, for example, a gyroscope, etc. can be used.

The steering wheel 32 generates a steering signal according to the steering angle of the driver 40 and outputs the steering signal to the automatic control device 11 via the in-vehicle network 13. The monitoring device 12 stores the steering signal together with the time when the steering signal is input.

The accelerator pedal 34 generates an accelerator signal according to the degree of accelerator pedal opening of the driver 40 and outputs the accelerator signal to the automatic control device 11 via the in-vehicle network 13.

The brake pedal 33 generates a brake signal according to the brake amount of the driver 40 and outputs the brake signal to the automatic control device 11 via the in-vehicle network 13.

The UI 7 is an exemplary notification unit. The UI 7 is controlled by the automatic control unit 11 and monitoring device 12 to notify the driver 40 of the information about the vehicle 10. The UI 7 has a display device 7a, such as an LCD display or a touch panel, for displaying the information. In addition, the UI 7 may have an audible output device (not shown) for notifying the driver of information. In addition, the UI 7 has, for example, a touch panel or control buttons as input devices for inputting operational information from the driver to the vehicle 10. The UI 7 outputs the input information to the automatic control device 11 and the monitoring device 12, etc., via the in-vehicle network 13.

The positioning information receiving device 8 outputs positioning information that represents the current location of the vehicle 10. The positioning information receiving device 5 may be a GNSS receiver, for example. The positioning information receiving device 8 outputs the positioning information and the positioning information acquisition time at which the GNSS information has been acquired, to the navigation device 9 and the monitoring device 12, etc., each time the GNSS information is acquired at a predetermined receiving cycle.

Based on the navigation map information, the destination location of the vehicle 10 input through the UI 7, and positioning information representing the current location of the vehicle 10 input from the positioning information receiver 8, the navigation device 9 creates a navigation route from the current location to the destination location of the vehicle 10. The navigation route includes information relating to the locations of right turns, left turns, merging and branching. The navigation route also includes information about intersections such as the roundabout. When the destination location has been newly set or the current location of the vehicle 10 has exited the navigation route, the navigation device 9 creates a new navigation route for the vehicle 10. Every time a navigation route is created, the navigation device 9 outputs the navigation route to the automatic control device 11 and the monitoring device 12, etc., via the in-vehicle network 13.

The monitoring device 12 carries out control processing, detection processing, determination processing, and change processing. For this purpose, the monitoring device 12 has a communication interface (IF) 21, a memory 22 and a processor 23. The communication IF 21, the memory 22 and the processor 23 are connected via a signal wire 24 The communication IF 21 has interface circuitry to connect the monitoring device 12 with the in-vehicle network 13.

The memory 22 is an example of a storage unit, and it has a volatile semiconductor memory and a non-volatile semiconductor memory, for example. The memory 22 stores an application computer program and various data to be used for information processing carried out by the processor 23.

All or some of the functions of the monitoring device 12 are carried out by functional modules driven by a computer program operating on the processor 23, for example. The processor 23 has a control unit 231, a detecting unit 232, determining unit 233 and changing unit 234. The determining unit 233 is an example of the first determining unit, the second determining unit and the third determining unit. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit.

The automatic control device 11 and the monitoring device 12 are, for example, electronic control units (ECUs). Although the automatic control device 11 and the monitoring device 12 are described as separate devices (e.g., Electronic Control Units: ECUs) in FIG. 2, these devices may be configured as a single device.

The control unit 231 controls the operation of the vehicle 10. The control unit 231 detects an object around the vehicle 10 and its type (for example, a vehicle) based on a detection result of a sensor such as a camera (not shown). The control unit 231 controls the operation of the vehicle 10 based on the detection results.

The control unit 231 has the automatic operation mode for driving the vehicle 10 in automatic operation, and the manual operation mode for controlling the operation of the vehicle 10 based on the operation of the driver 40. In the automatic operation mode, the control unit 231 primarily drives the vehicle 10. In the automatic operation mode, the control unit 231 controls operation such as steering, driving, and braking, based on the current position of the vehicle 10, map information and the detection results of a sensor (not shown) such as a camera mounted on the vehicle 10.

In the manual operation mode, the control section 231 controls the operation of the vehicle 10 such as steering, driving, and braking, based on the operation of the driver 40. In the manual operation mode, the driver 40 primarily drives the vehicle 10. The control unit 231 controls the operation of the vehicle 10 based on the operation of at least one of the steering wheel 32, the brake pedal 33 and the accelerator pedal 34 by the driver 40 in the manual operation mode.

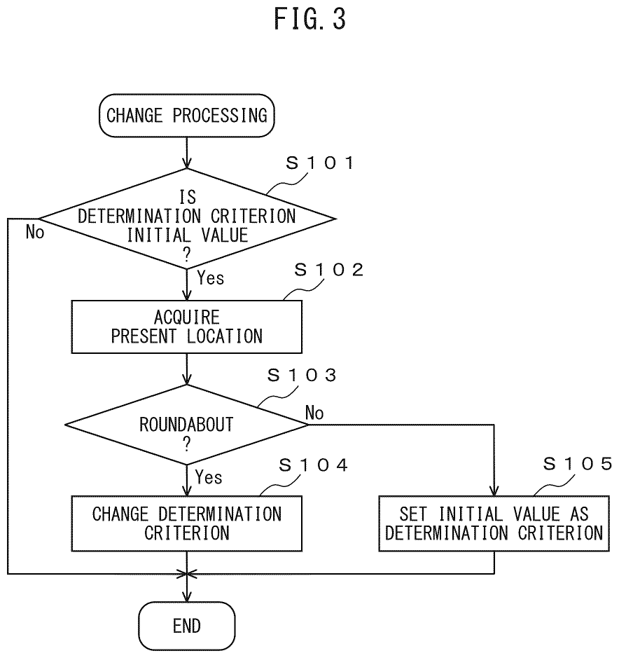

FIG. 3 is an example of an operation flow chart for change processing by the monitoring device 12 of the present embodiment. In the change processing, the determination criterion for determining whether the driver 40 is looking aside is changed. The monitoring device 12 carries out the change processing as shown in FIG. 3, at a change time with a predetermined cycle. As the cycle of the change time, for example, can be from 0.1 second to 1 second. The monitoring device 12 carries out the change processing, even when the automatic control device 11 is in either the automatic operation mode or the manual operation mode.

First, the determining unit 233 determines whether the determination criterion for determining whether the driver is looking aside is the initial value or not (step S101). The determination criterion will be described later.

When the determination criterion is the initial value (step S101-Yes), the determining unit 233 acquires the present location of the vehicle 10 (step S102). The determining unit 233 inputs the current location of the vehicle 10 sent from the positioning information receiver 8 via the in-vehicle network 13.

Next, the determining unit 233 determines whether the present position of the vehicle 10 is within the roundabout based on the map information (step S103). The determining unit 233 refers to the map information of a predetermined area including the current location of the vehicle 10 input from the navigation device 9 and determines whether the current position of the vehicle 10 is within a roundabout.

If the present position of the vehicle 10 is within the roundabout (step S103-Yes), the changing unit 234 changes the determination criterion so that it has not been determined that the driver is looking aside when the face of the driver is facing in the direction of an entry point of another vehicle into the roundabout (step S104), and the series of processing steps is complete.

The changing unit 234 acquires a direction in which the exit point is located with respect to the traveling direction of the vehicle 10 within the roundabout based on the map information. The determination criterion is changed so that it has not been determined that the driver is looking aside when the face of the driver is facing in the direction of the entry point with respect to the traveling direction of the vehicle 10.

The determination of whether the driver 40 is looking aside is carried out based on the horizontal angle of the direction of the face of the driver 40. If a state in which the direction of the face of the driver 40 is at or above a reference angle persists at or above a reference time, it is determined that the driver 40 is looking aside.

The direction of the face of the driver 40 is represented, for example, by the angle in the horizontal direction between the traveling direction of the vehicle 10 and the direction in which the face of the driver 40 is facing. For example, when the traveling direction of the vehicle 10 is 0 degrees, the direction of the face of the driver 40 when facing left is represented as an angle between 0 degrees and −180 degrees, while the direction of the face of the driver 30 when facing right is represented as an angle between 0 degrees and 180 degrees.

As for the determination criterion of the initial value in the case of left side passage, the reference angle is at or above an angle of 30 degrees to the right and 40 degrees to the left with respect to the traveling direction of the vehicle 10 (−40 degrees with respect to the traveling direction of the vehicle 10 as 0 degrees). The reference time is a total of 10 seconds during the determination period of 30 seconds.

The changing unit 234 changes the reference angle and/or the reference time for the determination criterion. In the example shown in FIG. 1A, the entry points 51a˜54a are located on the left side with respect to the traveling direction of the vehicle 10. Therefore, the changing unit 234 may change the reference angle from −40 degrees to −90 degrees. Thus, even if the face of the driver 40 is facing in the direction of the entry points 51a˜54a, it will almost never be determined that the driver is looking aside.

The changing unit 234 may also change the reference angle from −40 degrees to −180 degrees. In this case, substantially, no looking aside area is set in the left side with respect to the traveling direction of the vehicle 10.

The changing unit 234 may change the reference time from 10 seconds to 20 seconds. Furthermore, the changing unit 234 may change the reference time to the same time as the determination period of 30 seconds. Thus, even if the face of the driver 40 is facing in the direction of the entry points 51a˜54a, it will almost never be determined that the driver is looking aside.

On the other hand, if the present position of the vehicle 10 is not within a roundabout (step S103-No), the changing unit 234 sets the determination criterion to the initial value (step S105), and the series of processing steps is complete.

Further, when the determination criterion is not the initial value (step S101-No), the series of processing steps is complete. No new change processing is required, since the determination criterion has already been changed.

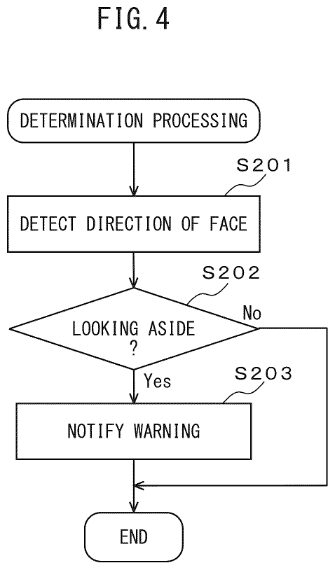

FIG. 4 is an example of an operation flowchart for determination processing by the monitoring device 12 of the present embodiment. The monitoring device 12 carries out the determination processing of the driver 40 looking aside according to the operation flowchart shown in FIG. 4 using the determination criterion that has been changed or set by the above-described change processing at a determination time with a predetermined cycle. The cycle of the determination time may be appropriately set according to the determination period required for the determination of looking aside. The cycle of the determination time, for example, can be from 30 seconds to 60 seconds. The monitoring device 12 carries out the determination processing, even when the automatic control device 11 is in either the automatic operation mode or manual operation mode.

First, the detecting unit 232 detects a direction of the face of the driver 40 (step S201). The detecting unit 232 detects a position of a predetermined portion included in the monitoring image by inputting the monitoring image to a classifier trained to classify a predetermined portions of a face such as an eye corner, an inner eye corner and a mouth angle. The detecting unit 232 compares the positions of the predetermined portions detected from the monitor image against a standard facial three-dimensional model. The angle of the face in a three-dimensional model in which the position of each portion maximally matches the position detected from the monitor image is detected as the angle of the face in the monitoring image. The monitoring image is an example of information representing the direction of the face of the driver 40.

The classifier may be a deep neural network (DNN) having multiple layers connected in series from the input end to the output end, for example. Facial images including predetermined facial portions are previously input into the DNN as teacher data for learning, whereby the DNN functions as a classifier to identify the positions of predetermined facial portions.

The direction of the face of the driver 40 is represented by the angle in the horizontal direction between the traveling direction of the vehicle 10 and the direction in which the face of the driver 40 is facing. For example, when the traveling direction of the vehicle 10 is 0 degrees, the direction of the face of the driver 40 when facing left is represented as an angle between 0 degrees and −180 degrees, while the direction of the face of the driver 30 when facing right is represented as an angle between 0 degrees and 180 degrees.

The detecting unit 232 determines the position of the center of the pupil and the position of the center of the eyeball based on the positions of the eye corner and the inner eye corner, and estimates the direction connecting the position of the center of the eyeball and the position of the center of the pupil as the line-of-sight direction of the driver 40. The detecting unit 232 may determine the direction of the face of the driver 40 based on the gaze direction of the driver 40.

Next, the determining unit 233 determines whether the driver 40 is looking aside using the determination criterion that has been changed or set by the changing unit 234 (step S202). The determining unit 233 determines that the driver 40 is looking aside if a state in which the direction of the face of the driver 40 is at or above the reference angle persists at or above the reference time.

If the driver 40 is looking aside (step S202-Yes), the control unit 231 notifies the driver 40 of the warning via the UI 7 (step S203), and the series of processing steps is complete. For example, the control unit 231 outputs a large warning sound via the U17 and displays a warning on the display device 7a. In this way, the monitoring system 12 increases the degree of involvement in driving for the driver 40.

On the other hand, if the driver 40 is not looking aside (step S202-No), the series of processing steps is complete.

In the example shown in FIG. 1A, the entry points 51a˜54a frequently appear when the vehicle 10 is traveling on the ring road 501. For example, when the vehicle 10 approaches the entry point 51a, the driver 40 looks at the entry point 51a and determines whether the vehicle 60 is about to enter the ring road 501 from the entry point 51a.

In the monitoring device 12, the monitoring device 12 does not substantially determine that the driver 40 is looking aside, since the determination criterion is changed so that it has not been determined that the driver 40 is looking aside when the face of the driver 40 is facing in the direction of an entry point of another vehicle into the roundabout 50.

As described in detail above, it is possible to prevent the driver from being notified of the warning, since the monitoring device of the present embodiment does not determine that the driver is looking aside, even if the driver is looking at the entry point of another vehicle into the roundabout.

In the prior art, it has also been proposed to relax the determination criterion of looking aside when the vehicle is traveling within the intersection. However, in the prior art, the vehicles were traveling in the intersections at speeds of, for example, 20 km/h or less. Therefore, the determination criterion for looking aside has been relaxed with the speed of the vehicle relatively slow. On the other hand, the vehicles can travel at the speed limit (at or above 20 km/h) in the roundabout. The monitoring device of the present embodiment proposes to relax the determination criterion of looking aside, even when the vehicle is traveling at a relatively high speed.

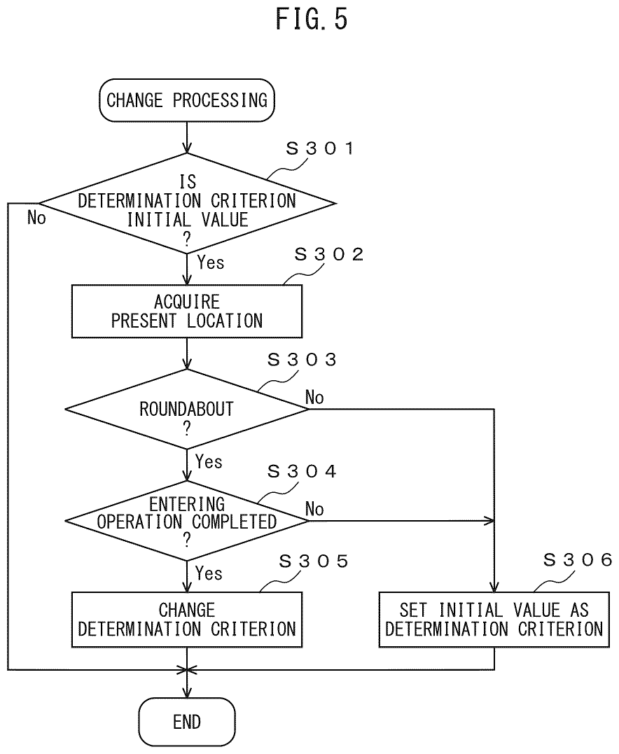

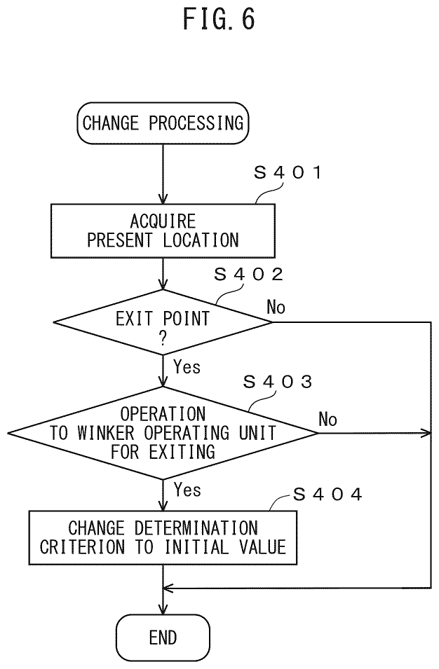

Next, modified examples 1 and 2 of the monitoring device 12 described above will be explained below with reference to FIGS. 5 and 6.

FIG. 5 is an example of an operation flowchart by a modified example 1 of the monitoring device 12 of the present embodiment. In this modified example, the processing of a step S304 is added to the operation flow chart of the change processing shown in FIG. 3 described above. The processing for steps S301˜S303, S305 and S306 are the same as in steps S101˜S105 described above.

If the present position of the vehicle 10 is within the roundabout (step S303-Yes), the determining unit 233 determines whether entering operation of the vehicle 10 into the roundabout has been completed (step S304).

Specifically, the determining unit 233 acquires steering angles based on the steering signal input from the steering wheel 32. When the steering angle of the steering wheel 32 of the vehicle 10 becomes zero from a steering angle in the first direction for entering the roundabout and becomes a steering angle in the second direction opposite to the first direction, the determining unit 233 determines that the entering operation of the vehicle 10 into the roundabout has been completed.

In some embodiments, the determining unit 233 determines whether the entering operation of the vehicle 10 into the roundabout has been completed based on the steering signal during a predetermined determination period including the time before and after the time when the current position of the vehicle 10 is determined to be within the roundabout. The determination period, for example, can be 3 seconds to 5 seconds.

In the example shown in FIG. 1A, the vehicle 10 turns left from the road 52 and enters the roundabout 50. The vehicle 10 turns left at the entry point 52a and enters the ring road 501 from the lane 521 of the road 52.

At the entry point 52a, the driver 40 steers the steering wheel 32 to the left and the vehicle 10 enters the ring road 501 from the road 52. The driver 40 steers the steering wheel 32 so that the steering angle becomes an angle in the right direction from an angle in the left direction, since the ring road 501 curves clockwise within the roundabout 50.

The determining unit 233 determines that the entering operation of the vehicle 10 into the roundabout 50 has been completed, when the steering angle of the steering wheel 32 becomes zero from the steering angle to the left and becomes the steering angle to the right opposite to the left

In addition, the determining unit 233 may determine that the entering operation of the vehicle 10 into the roundabout has been completed when a yaw rate of the vehicle 10 that is input from the angular velocity sensor 5 changes from a yaw rate in the first direction for entering the roundabout to zero and changes to a yaw rate in the second direction opposite to the first direction.

In some embodiments, the determining unit 233 determines whether the entering operation of the vehicle 10 into the roundabout has been completed based on the yaw rate during a predetermined determination period including the time before and after the time when the current position of the vehicle 10 is determined to be within the roundabout. The determination period, for example, can be from 3 seconds to 5 seconds.

In the example shown in FIG. 1A, the determining unit 233 determines that the entering operation of the vehicle 10 into the roundabout 50 has been completed when the yaw rate of the vehicle 10 that is input from the angular velocity sensor 5 changes from a yaw rate in the left direction for entering the roundabout 50 to zero and changes to a yaw rate in the right direction.

If the entering operation into the roundabout of the vehicle 10 has been completed (step S304-Yes), the changing unit 234 changes the determination criterion (step S305), and the series of processing steps is complete.

On the other hand, if the entering operation into the roundabout of the vehicle 10 has not been completed (step S304-No), the changing unit 234 sets the determination criterion to the initial value (step S306), and the series of processing steps is complete.

According to the present modified example described in detail above, the monitoring device can change the determination criterion after the vehicle has completely entered the roundabout. When a vehicle enters a roundabout, it is accompanied by an operation to turn left or right. The monitoring device monitors the driver using the determination criterion of the initial value when the vehicle turns left or right. As described above, when a vehicle is turning left or right, the vehicle travels slowly (e.g., travels at speed below 20 km/h), so that the monitoring device may not monitor the driver looking aside.

FIG. 6 is an example of an operation flowchart by a modified example 2 of the monitoring device 12 of the present embodiment. In this modified example, the monitoring device 12 changes the determination criterion for looking aside to the initial value, when the vehicle 10 exits the roundabout. The monitoring device 12 carries out the change processing according to the operation flowchart shown in FIG. 6 at the change time with a predetermined cycle. The cycle of the change time, for example, can be from 0.1 second to 1 second. The monitoring device 12 carries out the change processing, even when the automatic control device 11 is in the manual operation mode.

First, the determining unit 233 acquires the present location of the vehicle 10 (step S401). The determining unit 233 inputs the current location of the vehicle 10 sent from the positioning information receiver 8 via the in-vehicle network 13.

Next, the determining unit 233 determines whether the present position of the vehicle 10 is at the exit point of a roundabout based on the map information (step S402). The determining unit 233 refers to the map information of a predetermined area including the current location of the vehicle 10 input from the navigation device 9 and determines whether the current location of the vehicle 10 is at the exit point of the roundabout.

The determining unit 233 determines that the current position of the vehicle 10 is at the exit point of the roundabout when the current position of the vehicle 10 is within a predetermined reference distance with respect to the connecting position between the ring road and the road connected to the ring road. The reference distance, for example, can be from 10 m to 15 m.

If the present position of the vehicle 10 is at the exit point (step S402-Yes), the determining unit 233 determines whether operation to the winker operating unit 4 representing a change in a traveling direction of the vehicle 10 for exiting the roundabout has been carried out (step S403).

In the example shown in FIG. 1A, the driver 40 turns the vehicle 10 left at the exit points 51b˜54b and the vehicle 10 enters the roads 51-54, when the driver 40 wishes to exit the roundabout 50. The driver 40 operates the winker operating unit 4 so as to indicate that the traveling direction of the vehicle 10 is changed to the left.

If the winker operation signal represents changing the traveling direction of the vehicle 10 to the left, the determining unit 233 determines that the operation to the winker operating unit 4 representing the change of the traveling direction of the vehicle 10 for exiting the roundabout has been carried out.

When the operation to the winker operating unit 4 representing the change of the traveling direction of the vehicle 10 for exiting the roundabout has been carried out (step S403-Yes), the changing unit 234 changes the determination criterion to the initial value before changing the determination criterion (step S404), and the series of processing steps is complete.

In the example shown in FIG. 1A, after the operation to the winker operating unit 4 by the driver 40 has been carried out, the vehicle 10 turns left at the exit points 51b˜54b and exits the ring road 501. When the vehicle 10 is turning left, the monitoring device 12 monitors the driver 40 using the determination criterion of the initial value.

On the other hand, if the present position of the vehicle 10 is not at the exit point (step S402-No), or if the operation to the winker operating unit 4 representing the change of the traveling direction of the vehicle 10 for exiting the roundabout has not been carried out (step S403-No), the series of processing steps is complete. In the step S403, even when the operation to the winker operating unit 4 is not input, the determining unit 233 determines that the operation to the winker operating unit 4 representing the change of the traveling direction of the vehicle 10 for exiting the roundabout has not been carried out.

According to the present modified example described in detail above, it is possible to monitor the driver using the determination criterion of the initial value when the vehicle turns left or right to exit the roundabout. As described above, when a vehicle is turning left or right, the vehicle travels slowly (e.g., travels at speed below 20 km/h), the monitoring device may not monitor the driver looking aside.

In the present disclosure, the monitoring device according to the embodiments described in the present disclosure may incorporate appropriate modifications that still fall within the gist of the disclosure. Moreover, the technical scope of the disclosure is not limited to these embodiments and includes the present disclosure and its equivalents as laid out in the claims.

For example, in the above-described embodiment, the changing unit may change the determination criterion to be relaxed for the face of the driver facing in the curved direction of a road on which the host vehicle is traveling, when it has been determined by the determining unit that the current position of the host vehicle is within the roundabout. In the example shown in FIG. 1A, the changing unit may change the reference angle from 30 degrees to 90 degrees. Thus, it is possible to prevent the driver from being determined as looking aside for the face of the driver facing the traveling direction of the host vehicle, when the host vehicle is traveling within the roundabout.

In addition, the processing for obtaining the direction of the face of the driver is merely an example in the above-described embodiment, and is not limited thereto. Further, the processing for determining whether the driver is looking aside is an example in the above-described embodiment and is not limited thereto.

1. A monitoring device comprising:
a processor configured to
determine whether a driver is looking aside based on information representing a direction of a face of the driver using a predetermined determination criterion,
determine whether a current position of a host vehicle is within a roundabout based on map information, and
change the determination criterion so that it has not been determined that the driver is looking aside when the face of the driver is facing in the direction of an entry point of another vehicle into the roundabout, when it has been determined that the current position of the host vehicle is within the roundabout.

2. The monitoring device according to claim 1, wherein the processor is further configured to determine that the current position of the host vehicle is within the roundabout when it has been determined that the current position of the host vehicle is within the roundabout based on the map information and it has been determined that entering operation of the host vehicle into the roundabout has been completed.

3. The monitoring device according to claim 2, wherein the processor is further configured to determine that the entering operation of the host vehicle has been completed when a steering angle of a steering wheel of the host vehicle becomes zero from a steering angle in a first direction for entering the roundabout and becomes a steering angle in a second direction opposite to the first direction, or when a yaw rate of the host vehicle changes from a yaw rate in the first direction to zero and changes to a yaw rate in the second direction.

4. The monitoring device according to claim 1, wherein the processor is further configured to
determine whether operation to a winker operating unit representing a change in a traveling direction of the host vehicle for exiting the roundabout has been carried out at an exit point where the host vehicle exits the roundabout, and
change the determination criterion to an initial value before the change of the determination criterion, when it has been determined that the operation to the winker operating unit is carried out.

5. The monitoring device of claim 1, wherein the processor is further configured to change the determination criterion to be relaxed for the face of the driver facing in a curved direction of a road on which the host vehicle is traveling, when it has been determined that the current position of the host vehicle is within the roundabout.
